(19) United States
(12) Patent Application Publication
(10) Pub. No.: US 2013/0209853 A1
(43) Pub. Date: Aug. 15, 2013

(54) BATTERY HAVING A COOLING PLATE AND MOTOR VEHICLE HAVING A CORRESPONDING BATTERY

(71) Applicants: Boris Gendlin, Filderstadt (DE); Marc Dill, Stuttgart (DE); Ralf Angerbauer, Moglingen (DE); Conrad Bubeck, Esslinger (DE); Andreas Ruehle, Stuttgart (DE)

(72) Inventors: Boris Gendlin, Filderstadt (DE); Marc Dill, Stuttgart (DE); Ralf Angerbauer, Moglingen (DE); Conrad Bubeck, Esslinger (DE); Andreas Ruehle, Stuttgart (DE)

(21) Appl. No.: 13/643,524

(22) PCT Filed: Feb. 28, 2011
(86) PCT No.: PCT/EP2011/052888

§ 371 Date: Mar. 1, 2013

(30) Foreign Application Priority Data
Apr. 26, 2010 (DE) 10 2010 028 194.8

(51) Int. Cl. H01M 2/10

(52) U.S. Cl. CPC H01M 2/10
USPC 429/100

(57) ABSTRACT

A battery includes at least one battery module having a lower face, a cooling plate having an upper face, and a fixing system configured for the at least one battery module. The at least one battery module is arranged on the upper face of the cooling plate and connected to the cooling plate. The fixing system has at least one fixing strap. The at least one battery module is fixed on the cooling plate by the at least one fixing strap in such a way that the lower face of the battery module is in direct contact with the upper face of the cooling plate. A motor vehicle includes the battery.

The present invention relates to a battery having a cooling plate and a motor vehicle having this battery, wherein the battery by virtue of the embodiment of a fastening system renders possible a particularly efficient assembly and cooling.

PRIOR ART

It is known to arrange battery modules with their lower face on an upper face of a cooling plate. In this case, bore holes are arranged in the cooling plate and the battery modules are connected by means of screw connections to the cooling plate. This has the disadvantage that it is necessary to perform the screw connections from a lower face of the cooling plate, which leads to a complicated assembly process. In addition, a defined contact pressure of the battery module on the cooling plate can only be achieved in a relatively costly manner by way of determining the resistance torque of the screws as they are screwed in. The contact pressure should achieve a defined level such that a thermal transition resistance between the battery modules and the cooling plate is as low as possible.

A further option of the arrangement is known from DE 10 2007 063 187 B3. This document discloses a battery, in particular for hybrid-driven motor vehicles, which battery is to be used in the case of accidents in order to transmit force in a purposeful manner, is to be simple to produce and is to be light in weight. In addition thereto, a force distributing plate is arranged directly or indirectly over the cells, i.e. on the pole side, which force distributing plate is used initially to distribute any forces that occur in the case of accidents in the direction of the cells of the battery in such a manner that the distributed forces are directed towards the cooling plate by means of casings of cells and by means of cooling fins.

In addition, it is known to connect a plurality of battery cells to a battery module by means of retaining straps, such as are disclosed by way of example in U.S. Pat. No. 6,512,347 B1. Although the plurality of battery cells are consequently positioned with respect to each other, it is, however, consequently not provided that the battery module is fixed to a cooling plate.

### DISCLOSURE OF THE INVENTION

In accordance with the invention, a battery is provided that comprises at least one battery module having a lower face, a cooling plate having an upper face and a fastening system for the at least one battery module, which fastening system is arranged on the upper face of the cooling plate and is connected to the cooling plate, wherein the fastening system comprises at least one fixing strap. The at least one battery module is fastened to the cooling plate by means of the at least one fixing strap in such a manner that the lower face of the battery module is in direct contact with the upper face of the cooling plate.

It is consequently rendered possible in an advantageous manner to arrange battery modules on the cooling plate, without it being necessary to access the lower face of the cooling plate. During an assembly of the battery in accordance with the invention it is no longer necessary to rotate the cooling plate, as a consequence of which the assembly process is simplified. The fixing strap renders it possible to fix battery modules advantageously in a simple and rapid manner with a few manipulations. Consequently, the battery in accordance with the invention can be assembled and maintained in a simpler and more rapid manner. In accordance with the invention, the battery is preferably a Li-ion battery.

In a preferred embodiment of the invention it is provided that by means of the fastening system the at least one battery module is fastened to the cooling plate with a predefined contact pressure, preferably with a contact pressure of at least 3 bar, more preferably of at least 5 bar. A smallest possible thermal transition resistance between the lower face of the battery module and the cooling plate is produced in an advantageous manner by means of the defined contact pressure.

In a further preferred embodiment of the invention it is provided that the direct contact of the lower face of the battery module with the upper face of the cooling plate is embodied in a heat conducting manner. Consequently, it is rendered possible to achieve in an advantageous manner an efficient discharge of the heat of the battery module.

In a further preferred embodiment of the invention it is provided that the at least one fixing strap is embodied in a planar manner, at least the face of the strap that is lying on the battery module. Consequently, in an advantageous manner with an identical level of force, less pressure is exerted on the battery cells, in particular on the two outer battery cells of the battery module. The fixing straps themselves are consequently in addition exposed to less loading and simultaneously require less installation space.

In a further preferred embodiment of the invention, it is provided that the at least one fixing strap is made from metal. The material properties of the metal, in particular the high tensile strength and the high heat conducting coefficient, advantageously provide on the one hand a good durability of the construction and on the other hand they provide the facility also to simultaneously perform a cooling function using the fixing strap.

In a further preferred embodiment of the invention, it is provided that the at least one fixing strap is embodied from two part-fixing straps that are joined together under tensile stress. As a consequence, the fixing strap is permanently stressed in an advantageous manner in an efficient method step. In addition, the part-fixing straps render it possible to position the at least one battery module in a simple manner.

In a further preferred embodiment of the invention, it is provided that the lower face of the battery module directly contacts in its entirety the upper face of the cooling plate. As a consequence, the battery module is connected with the largest possible surface area of its lower face to the cooling plate, as a consequence of which the cooling effect is advantageously enhanced.

In a further preferred embodiment of the invention, it is provided that the cooling plate comprises at least two cut-outs that are arranged in a mutually spaced disposition and the at least one fixing strap is guided through these cut-outs in the manner that a first section of the at least one fixing strap is arranged above the cooling plate and a second section of the at least one fixing strap is arranged below the cooling plate. In this case, the term ‘above the space’ defines the space which the upper face of the cooling plate faces and the term ‘below the space’ defines the space from which the upper face of the cooling plate is remote. In so doing, it is rendered possible in an advantageous manner to fix the at least one battery module in a durable and permanent manner.

Preferably, the at least one fixing strap is fastened using a fastening means to and/or on the cooling plate.

In a further preferred embodiment of the invention it is provided that the cooling plate comprises cooling medium ducts. The cooling ducts enable the cooling medium to flow through the cooling plate in an advantageous manner and the cooling capacity is increased.

In addition, a motor vehicle is provided in accordance with the invention, said motor vehicle having a battery in the aforementioned embodiments, wherein the battery is connected to a drive system of the motor vehicle. The advantages of the battery in accordance with the invention as a component part are also imparted in this way to the motor vehicle as an assembly group.

Advantageous embodiments of the invention are disclosed in the subordinate claims and described in the description.

The term ‘battery’ in this application also includes battery systems, accumulator batteries, accumulators, accumulator systems, in particular Li-ion systems or Li-ion polymer systems.

### DRAWINGS

The invention is explained in detail with reference to a drawing and the description hereinunder.

FIG. 1 illustrates an arrangement in accordance with the invention of a battery module on a cooling plate.

### EMBODIMENTS OF THE INVENTION

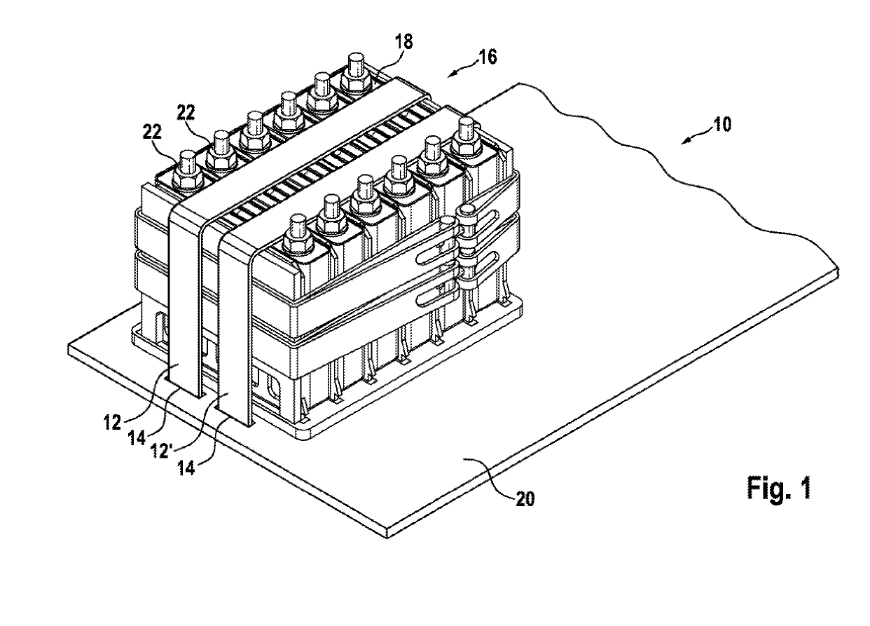

An example of a cooling plate 10 in accordance with the invention is illustrated in FIG. 1. This cooling plate 10 comprises an upper face 20. In this case, two fixing straps, a first fixing strap 12 and a second fixing strap 12′, are arranged on the cooling plate 10. A battery module 16 is fixed on the upper face 20 of the cooling plate 10 by means of fixing straps 12, 12′. The battery module 16 is preferably embodied from a plurality of battery cells 18 that are arranged in a row. In this case, the lower face of the battery module is preferably embodied in such a manner that the battery module 16 lies in a planar manner with its lower face on the upper face 20 of the cooling plate 10.

The cooling plate 10 is used to cool the at least one battery module 16. For this purpose, the cooling plate 10 is preferably made from metal, since metals have a high heat conducting coefficient. The battery module 16 is in direct contact with the cooling plate 10 after assembly. Preferably, the lower face of the battery module 16 directly contacts the upper face 20 of the cooling plate 10. In this case, the lower face of the battery module 16, preferably the entire lower face of the battery module 16, is connected in a heat-conducting manner to the upper face 20 of the cooling plate 10. An air gap that represents a thermal resistance is not provided between the lower face of the battery module 16 and the upper face 20 of the cooling plate 10. It is also possible that the lower face of the battery module 16 or the upper face 20 of the cooling plate 10 is embodied with a heat-conductive paste in order to reduce further the thermal resistance.

It is also possible in accordance with the invention that the cooling plate 10 comprises cooling medium ducts through which a fluid cooling medium can flow and thus can provide an additional cooling capacity.

FIG. 1 illustrates by way of example, but in a non-limiting manner, the use of two fixing straps 12, 12′ in order to fix a battery module 16. However, it is also possible in FIG. 1 to use only one fixing strap or to use more than two fixing straps 12. The fixing straps 12, 12′ are arranged in FIG. 1 in a mutually spaced disposition on the cooling plate 10. In accordance with the invention, the fixing straps 12, 12′ are preferably made from metal. They can, however, also be made from a synthetic material or from a composite material of synthetic material and metal.

The straps are preferably embodied in a substantially planar manner; preferably at least the face of the fixing strap 12, 12′ that lies on the battery module 16 is embodied in a planar manner. Each fixing strap 12, 12′ is in this case preferably, but in a non-limiting manner, guided at two mutually remote sites on the cooling plate 10 through cut-outs 14 in the cooling plate 10 and forms in the assembled state together with the cooling plate 10 a closed form. At least a first section and a third section of the fixing strap 12, 12′ are consequently below the cooling plate 10 and a second section of the fixing strap 12, 12′ is above the cooling plate 10, wherein the term ‘above the space’ defines the space which the upper face 20 of the cooling plate 10 faces and the term ‘below the space’ defines the space from which the upper face 20 of the cooling plate 10 is remote. The second section of the fixing strap 12, 12′ is consequently arranged between the first section and the third section.

The first section and the third section of the fixing strap 12, 12′ comprise in accordance with the invention fastening means with which the fixing strap 12, 12′ is connected to the cooling plate 10. These fastening means can, for example, be elements having a larger dimension in comparison to the cut-outs 14, which elements as a result of their size prevent the fixing strap 12, 12′ from sliding through the cut-outs 14. These elements can be, for example, clamps by means of which the sections can be guided in such a manner that they are fixed. It is also possible in accordance with the invention that the first section of the fixing strap 12, 12′ is connected to the third section of the fixing strap 12, 12′ below the cooling plate 10. The fastening means can be omitted in this embodiment. In an exemplary embodiment the fixing strap 12, 12′ can be a closed, elastic strap. However, it is preferred that a fixing strap 12, 12′ comprises a plurality of part sections.

The at least one fixing strap 12, 12′ can also be connected in an exemplary embodiment without the embodiment of cut-outs 14 in any other manner to the cooling plate 10 by means of a fastening means, for example by means of adhering or stapling the at least one fixing strap 12, 12′ directly to the cooling plate 10.

The sections of the fixing straps 12 and 12′ that extend above the cooling plate 10 lie in this case in FIG. 1 on three faces of the battery module 16. The fact that a section of the strap lies on the face of the battery module 16 that lies opposite the lower face of the battery module 16 ensures that the battery module 16 is fixed on the cooling plate 10. In FIG. 1, this face represents the terminal side. The fixing straps 12 and 12′ each extend in this case between the two terminals of a battery cell 18. They do not represent in this case an electrical contact between the terminals 22.

In accordance with the invention, deviating from the illustration in FIG. 1, the face of the battery module 16 that lies opposite the lower face of the battery module 16 can also be a face other than the terminal side.

During an assembly of the battery in accordance with the invention, at least one fixing strap 12, 12′ is guided, stressed and fixed around at least one battery module 1b. The fixing strap 12, 12′ remains stressed by means of the positioned battery module 16 after the assembly. The stressing and fixing can be achieved in this case in a plurality of different ways.

Preferably, two part sections of the at least one fixing strap 12, 12′ are joined together after arranging the battery module 16 that is to be fixed with a corresponding device and then mutually fastened. It follows from this that in FIG. 1 a fixing strap 12 comprises a left-hand and a right-hand part section that are initially separate from each other. After the battery module 16 is placed between the left-hand and right-hand part section of the fixing strap 12, 12′, the two part sections are guided over the battery module 16 and mutually connected. Preferably, the part sections are mutually fastened after the connection in order to increase the contact pressure. The sections can be joined together in this case by welding, adhering or preferably clinching and/or TOX clinching. The fixing strap 12, 12′ can also be stressed and fixed by means of a thread, for example a screw thread in the form of a worm drive hose clip.

In an exemplary embodiment, the fixing strap 12, 12′ is initially stretched during the positioning of the battery module 16 and then the battery module 16 is urged between the cooling plate 10 and the fixing strap 12, 12′, preferably when the fixing strap 12, 12′ is made from synthetic material.

In a battery in accordance with the invention, fixing straps 12, 12′ can also be arranged simultaneously in different previously described embodiments.

The at least one fixing strap 12, 12′ and/or the part sections of the at least one fixing strap 12, 12′ are in this case fastened to and/or on the cooling plate 10 by means of a fastening means prior to arranging the battery module 16 in place, so that it is no longer necessary to be able to access the lower face of the cooling plate 10 or rotate it in order to arrange the battery module 16 in place.

If the battery module 16 is arranged in place and the at least one fixing strap 12, 12′ is stressed, then the fixing strap 12, 12′ by virtue of its elastic deformation exerts a continuous force on the battery module 16 in the substantially vertical direction and in the direction towards the upper face 20. As a consequence, the battery module 16 is arranged on the cooling plate 10 with a defined contact pressure. The defined contact pressure ensures a lowest possible thermal transition resistance between the battery module 16 and the cooling plate 10. In accordance with the invention, said contact pressure is at least 3 bar, more preferably 5 bar.

The number of fixing straps 12, 12′ is not limited in accordance with the invention to two, in accordance with the exemplary embodiment in FIG. 1. It is also possible to arrange only a single fixing strap 12, 12′ or to arrange more than two fixing straps 12, 12′. In this case, it is also possible differently than in FIG. 1 to fix more than one battery module 16 with each fixing strap 12, 12′.

1. A battery, comprising:
at least one battery module having a lower face,
a cooling plate having an upper face, and
a fastening system arranged on the upper face of the cooling plate and connected to the cooling plate,
wherein the fastening system comprises at least one fixing strap, and the at least one battery module is fastened to the cooling plate by the at least one fixing strap in such a manner that the lower face of the battery module is in direct contact with the upper face of the cooling plate.

2. The battery as claimed in claim 1, wherein the at least one battery module is fastened to the cooling plate by the fastening system with a predefined contact pressure.

3. The battery as claimed in claim 1, wherein the direct contact of the lower face of the battery module with the upper face of the cooling plate is embodied in a heat conducting manner.

4. The battery as claimed in claim 1, wherein the at least one fixing strap is configured in a planar manner.

5. The battery as claimed in claim 1, wherein the at least one fixing strap is made from metal.

6. The battery as claimed in claim 1, wherein the at least one fixing strap is configured from two part-fixing straps that are joined together under tensile stress.

7. The battery as claimed in claim 1, wherein the lower face of the battery module directly contacts in its entirety the upper face of the cooling plate.

8. The battery as claimed in claim 1, wherein the cooling plate comprises at least two cut-outs that are arranged in a mutually spaced disposition, and the at least one fixing strap is guided through these cut-outs in the manner that a section of the at least one fixing strap is arranged above the cooling plate and at least a further section of the at least one fixing strap is arranged below the cooling plate.

9. The battery as claimed in claim 1, wherein the at least one fixing strap is fastened using a fastening mechanism to the cooling plate.

10. A motor vehicle, comprising:
a battery including:
at least one battery module having a lower face,
a cooling plate having an upper face, and
a fastening system arranged on the upper face of the cooling plate and connected to the cooling plate,
wherein the fastening system comprises at least one fixing strap, and the at least one battery module is fastened to the cooling plate by the at least one fixing strap in such a manner that the lower face of the battery module is in direct contact with the upper face of the cooling plate,
wherein the battery is connected to a drive system of the motor vehicle.

11. The battery as claimed in claim 2, wherein the predefined contact pressure is at least 3 bar.

12. The battery as claimed in claim 2, wherein the predefined contact pressure is at least 5 bar.
